(19) United States
(12) Patent Application Publication
(10) Pub. No.: US 2025/0196492 A1
(43) Pub. Date: Jun. 19, 2025

(54) RECORDING DEVICE AND CONTROL METHOD THEREOF

(71) Applicant: CANON KABUSHIKI KAISHA, Tokyo (JP)

(72) Inventors: SEIKO MINAMI, Saitama (JP); NOBUYUKI HIRAYAMA, Kanagawa (JP); YUHEI OIKAWA, Kanagawa (JP); KOHEI SATO, Kanagawa (JP); TAKATSUGU MORIYA, Tokyo (JP)

(21) Appl. No.: 18/975,393

(22) Filed: Dec. 10, 2024

(30) Foreign Application Priority Data
Dec. 18, 2023 (JP) 2023-213090

(51) Int. Cl. B41J 2/045; B41J 2/14

(52) U.S. Cl. CPC B41J 2/0451; B41J 2/04541; B41J 2/04563; B41J 2/0458; B41J 2002/14354; B41J 2202/16

(57) ABSTRACT

Provided is a recording device including a driving unit of heaters; and temperature sensors disposed corresponding to the heaters respectively. A first drive signal and a second drive signal, of which heating of the heater is different from the first drive signal, are consecutively applied to a heater corresponding to a nozzle to be determined. Whether the nozzle to be determined is in a state of normally ejecting the liquid is determined based on a change rate of an output of the temperature sensor corresponding to the nozzle to be determined acquired when applying the first drive signal and a change rate thereof acquired when applying the second drive signal. During an interval between the first drive signal and the second drive signal, a drive signal is not applied to heaters corresponding to the nozzles other than the nozzle to be determined.

### BACKGROUND OF THE INVENTION

### Field of the Invention

The present invention relates to a recording device and a control method thereof.

### Description of the Related Art

Some inkjet type recording devices, which eject ink droplets from nozzles and allow the droplets to adhere to a recording medium, use a liquid ejection head having a heater, which generates thermal energy to eject ink, for each nozzle. In such a recording device, a method for determining ejection failure, due to clogging of a nozzle or the like, has been proposed. Japanese Patent Application Publication No. 2019-171673 discloses a method of determining an ejection state of a nozzle, where a temperature sensor is disposed for each nozzle, and the ejection state of the nozzle is determined based on the temperature change of the nozzle after the ejection.

In the ejection determination method according to Japanese Patent Application Publication No. 2019-171673, first processing is performed, where a first pulse is input to each of a plurality of heaters corresponding to a plurality of nozzles included in a liquid ejection head, and information on temperature change of each of the plurality of heaters is acquired. Then second processing is performed, where a second pulse is input to each of the plurality of heaters and information on temperature change of each of the plurality of heaters is acquired. Based on the information on the temperature change when the first pulse is input to a heater corresponding to a nozzle to be determined and information on the temperature change when the second pulse is input to the heater corresponding to the nozzle to be determined, acquired in the first processing and the second processing, the ejection determination is performed for the nozzle to be determined.

In the case of this determination method, time required for the first processing becomes longer as a number of heaters (nozzles) included in the liquid ejection head increases, and the second processing is performed after the first processing ends. In other words, the interval between a timing when the first pulse is input to a heater corresponding to a certain nozzle in the first processing and a timing when the second pulse is input to this heater in the second processing becomes longer than at least the time required for the first processing. Therefore, in this determination method, it is difficult to decrease the interval between the timing when the first pulse is input to a heater corresponding to the nozzle to be determined and the timing when the second pulse is input to this heater. If the interval is long, various conditions which influence the ejection state (e.g. temperature, humidity, state of liquid) at a timing when the first pulse is input may not match with the various conditions at the timing when the second pulse is input. In this case, accurate ejection determination cannot be performed.

### SUMMARY OF THE INVENTION

It is an object of the present invention to accurately determine an ejection state of each nozzle in a recording device using a liquid ejection head, which includes a heater, to generate thermal energy to eject liquid, for each nozzle.

The present invention is a recording device comprising:
a liquid ejection head;
a processor; and
a memory,
wherein the recording device is configured to perform recording on a recording medium using the liquid ejection head,
wherein the liquid ejection head including:
   a plurality of nozzles ejecting liquid;
   a plurality of heaters heating the liquid disposed corresponding to the plurality of nozzles respectively;
   a driving unit driving each of the plurality of heaters; and
   a plurality of temperature sensors disposed corresponding to the plurality of heaters respectively;
wherein the memory stores instructions that, when executed by the processor, causes the recording device to:
   consecutively apply a first drive signal and a second drive signal to a heater corresponding to a nozzle to be determined among the plurality of heaters by the driving unit, heating of the heater in a case where the second drive signal is applied being different from heating of the heater in a case where the first drive signal is applied, and
   determine whether the nozzle to be determined is in a state of normally ejecting the liquid based on a change rate of an output of a temperature sensor corresponding to the nozzle to be determined among the plurality of temperature sensors acquired in a case where the first drive signal is applied and a change rate thereof acquired in a case where the second drive signal is applied, and
wherein, during an interval between the first drive signal and the second drive signal applied for the determination, a drive signal is not applied to heaters corresponding to the nozzles other than the nozzle to be determined among the plurality of heaters.

The present invention is a control method of a recording device configured to perform recording on a recording medium using a liquid ejection head including a plurality of nozzles ejecting liquid; a plurality of heaters heating the liquid disposed corresponding to the plurality of nozzles respectively; a driving unit driving each of the plurality of heaters; and
a plurality of temperature sensors disposed corresponding to the plurality of heaters respectively,
   the control method comprising:
      a step of consecutively applying a first drive signal and a second drive signal to a heater corresponding to a nozzle to be determined among the plurality of heaters by using the driving unit, heating of the heater in a case where the second drive signal is applied being different from heating of the heater in a case where the first drive signal is applied;
      a step of acquiring a first output, which is an output of a temperature sensor corresponding to the nozzle to be determined among the plurality of temperature sensors in a case where the first drive signal is applied;
      a step of acquiring a second output, which is an output of the temperature sensor corresponding to the nozzle to be determined among the plurality of temperature sensors in a case where the second drive signal is applied; and
      a step of determining whether the nozzle to be determined is in a state of normally ejecting the liquid based on a change rate of the first output and a change rate of the second output,
   wherein, during an interval between the first drive signal and the second drive signal applied for the determination, a drive signal is not applied to heaters corresponding to the nozzles other than the nozzle to be determined among the plurality of heaters.

Further features of the present invention will become apparent from the following description of exemplary embodiments with reference to the attached drawings.

### BRIEF DESCRIPTION OF THE DRAWINGS

FIG. 1 is a perspective view indicating a recording device of an embodiment;

FIG. 2 is a block diagram indicating a control configuration of the recording device of the embodiment;

FIGS. 3A to 3C are diagrams indicating a configuration of an element substrate of the embodiment;

FIG. 4 is a perspective view of the element substrate of the embodiment;

FIG. 5 is a across-sectional view of the element substrate of the embodiment;

FIG. 6 is a schematic circuit diagram of a heater disposed on the element substrate of the embodiment;

FIG. 7 is a timing chart indicating an operation of the heater formed on the element substrate of the embodiment;

FIG. 8 is a schematic circuit diagram of a temperature sensor formed on the element substrate of the embodiment;

FIG. 9 is a timing chart indicating an operation of the temperature sensor disposed on the element substrate of the embodiment;

FIG. 10 is a diagram indicating a configuration of the element substrate of the embodiment;

FIG. 11 is a flow chart indicating an overview of ejection determination processing of Embodiment 1;

FIG. 12 is a flow chart indicating the ejection determination processing of Embodiment 1;

FIG. 13 is a timing chart indicating a drive signal of a heater in nozzle ejection determination processing of Embodiment 1;

FIGS. 14A to 14G are timing charts indicating the nozzle ejection determination processing of Embodiment 1;

FIG. 15 is a flow chart indicating ejection determination processing of a comparative example;

FIG. 16 is a timing chart indicating a drive signal of a heater in nozzle ejection determination processing of a comparative example;

FIGS. 17A to 17G are timing charts indicating the nozzle ejection determination processing of a comparative example;

FIGS. 18A to 18D are timing charts indicating nozzle ejection determination processing of Embodiment 2;

FIGS. 19A to 19 D are timing charts indicating nozzle ejection determination processing of Embodiment 3; and

FIGS. 20A to 20D are timing charts indicating nozzle ejection determination processing of Embodiment 4.

### DESCRIPTION OF THE EMBODIMENTS

Embodiments of the present invention will now be described with reference to the drawings. The following embodiments, however, are not intended to limit the scope of the invention according to the claims. A plurality of features are described in the embodiments, but all of these features are not essential to the invention, and these features may be arbitrarily combined. In the accompanying drawings, a same or similar composing element is denoted with a same reference number, and redundant description thereof will be omitted.

In the following embodiments, a device which ejects liquid, particularly an inkjet recording device that performs recording by ejecting ink (hereafter called “recording device”), will be described as an example. This recording device has a format of circulating the liquid between a tank and a liquid ejection device, but may have a different format. For example, two tanks may be disposed on the upstream side and downstream side of the liquid ejection device, so that the ink flows from one tank to the other tank, whereby ink in a pressure chamber is made to flow without circulating the ink.

Further, in the embodiments, a line type head, which has a length corresponding to the width of the recording medium, will be described as an example, but the present invention is also applicable to a serial type liquid ejection device, which performs recording while scanning the recording medium. The serial type liquid ejection device has a configuration, including one element substrate for each black ink and color ink, but the configuration is not limited to this. For example, a short line head, of which width is shorter than the recording medium, may be formed by disposing a plurality of element substrates such that the respective nozzles thereof overlap in the nozzle array direction, and the recording medium may be scanned with this line head.

### Embodiment 1

### Inkjet Recording Device

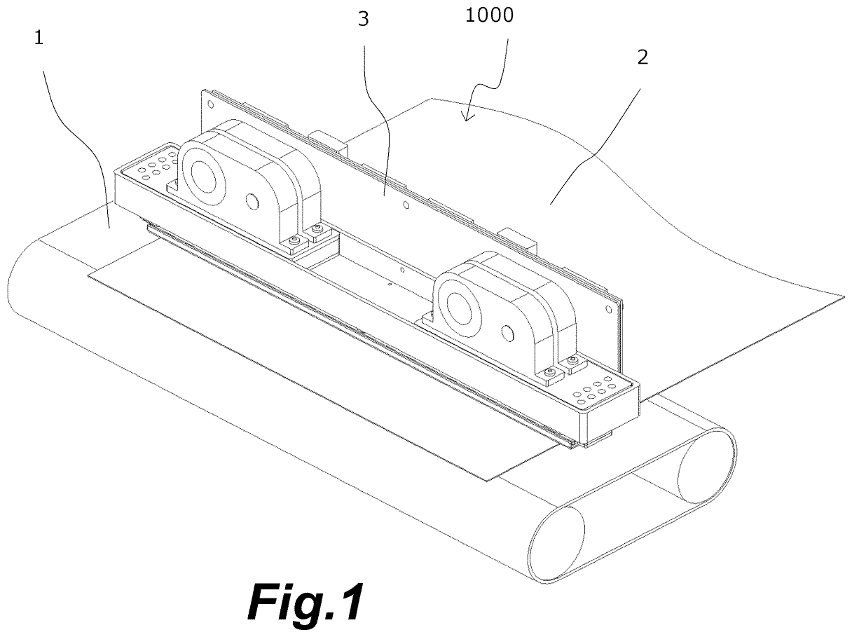

FIG. 1 is a diagram indicting a general configuration of a recording device 1000 of Embodiment 1. The recording device 1000 includes a conveying unit 1 which conveys a recording medium 2, and a liquid ejection head (recording head) 3 which is a line type liquid ejection device disposed approximately orthogonal to the conveying direction of the recording medium 2. The recording device 1000 is a line type recording device which performs continuous recording in one pass, while conveying a plurality of recording medium 2 continuously or intermittently. The liquid ejection head 3 is connected to liquid supply means, which is a supply passage to supply the liquid to the liquid ejection head 3.

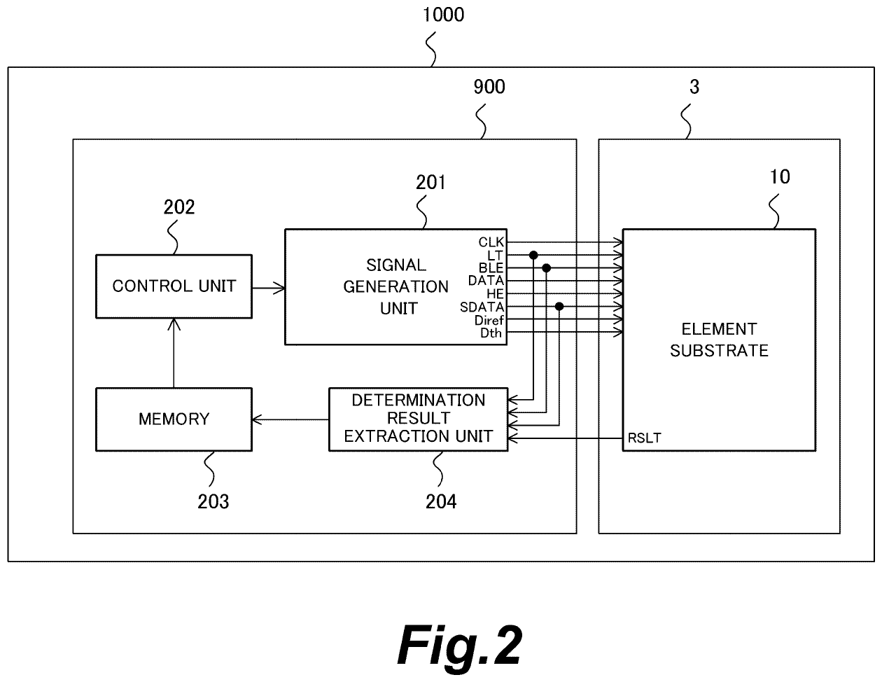

FIG. 2 is a block diagram indicating a control configuration of the recording device 1000. To the liquid ejection head 3, a control device 900, which transfers power and transmits an ejection control signal to the liquid ejection head 3, is electrically connected. The control device 900 controls the operation of the liquid ejection head 3, and inspects and determines the ejection state thereof.

Based on the instructions received from a control unit 202 of the control device 900, a signal generation unit 201 outputs a clock signal (CLK), a latch signal (LT), a block signal (BLE), a heater selection signal (DATA), and a heat enable signal (HE) to an element substrate 10. Further, the signal generation unit 201 outputs a sensor selection signal (SDATA), a constant current signal (Diref), and a threshold signal (Dth) related to the selection, the energization quantity and the processing of the output signals of a plurality of temperature sensors, which are disposed for the plurality of nozzles respectively.

A determination result extraction unit 204 receives a determination result signal (RSLT), which indicates a determination result on the ejection state of the nozzle of the element substrate 10 based on the temperature information detected by the temperature sensor, and extracts the determination result for each latch period, synchronizing with the fall of the latch signal LT. If the determination result indicates an ejection failure (state where liquid is not ejected normally), the determination result extraction unit 204 stores the block signal BLE and the sensor selection signal SDATA, corresponding to the determination result, in a memory 203.

The control unit 202 receives the block signal BLE and the sensor selection signal SDATA corresponding to the ejection failure recorded in the memory 203. If a heater to be driven corresponding to the ejection failure nozzle is included, the heater corresponding to the ejection failure nozzle is deleted from the heater selection signal DATA of this block. Then instead the control unit 202 adds a heater, corresponding to an ejection complementary nozzle, to the heater selection signal DATA of this block, and outputs the result to the signal generation unit 201.

### Structure of Element Substrate

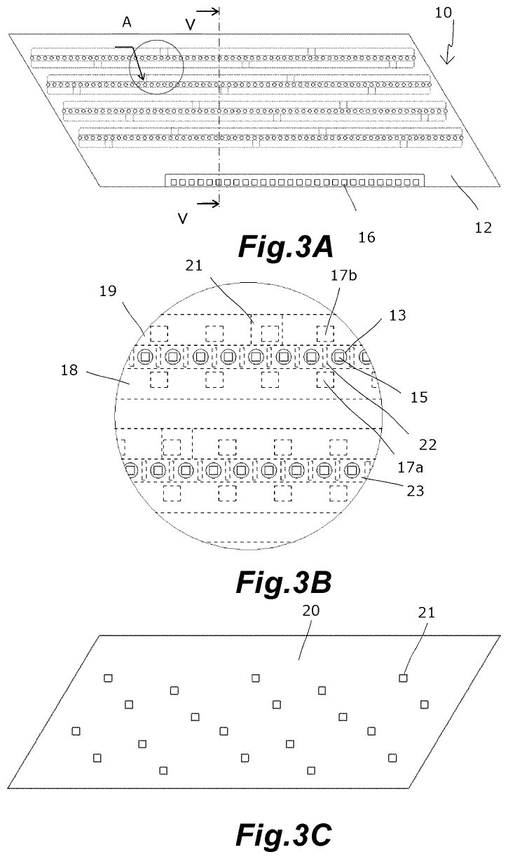

FIGS. 3A to 3C are diagrams indicating a configuration of the element substrate 10 disposed in the liquid ejection head 3 of Embodiment 1. FIG. 3A is a plan view of a surface of the element substrate 10 on the side where nozzles 13 are formed, FIG. 3B is an enlarged view of a portion indicated by the reference sign A in FIG. 3A, and FIG. 3C is a plan view of a rear surface of the surface indicated in FIG. 3A. As illustrated in FIG. 3A, 4 rows of nozzle arrays, which correspond to 4 colors of ink respectively, are formed on a nozzle forming member 12 of the element substrate 10. Hereafter, the direction in which each nozzle array, where a plurality of nozzles 13 are arrayed, is called a “nozzle array direction”.

As illustrated in FIG. 3B, the element substrate 10 includes a plurality of nozzles 13 (ejection ports) which eject liquid, and heaters 15 (heating element, heating resistor) which are disposed at positions corresponding to the nozzles 13 respectively and are used for heating and foaming the liquid by thermal energy. A pressure chamber 23, which includes a heater 15 inside, is partitioned by a barrier 22. The heater 15 is electrically connected to a terminal 16 in FIG. 3A via an electric wiring (not illustrated) disposed on the element substrate 10. The heater 15 includes a heating resistor which heats and boils the liquid based on a pulse signal input from the control device 900 (driving unit) via a flexible wiring board. The force of foaming caused by this boiling ejects the liquid from the nozzle 13. As illustrated in FIG. 3B, a liquid supply passage 18 extends along the nozzle array on one side in the direction crossing the nozzle array direction, and a liquid collection passage 19 extends along the nozzle array on the other side. The liquid supply passage 18 and the liquid collection passage 19 are passages extending in the nozzle array direction disposed on the element substrate 10, and communicate with the nozzles 13 via supply ports 17a and collection ports 17b respectively.

As illustrated in FIG. 3C, in the element substrate 10, a sheet type cover member 20 is layered on the rear face of the surface where the nozzles 13 are formed, and a plurality of openings 21, which communicate with the liquid supply passages 18 and the liquid collection passages 19 (described later), are formed in the cover member 20. In Embodiment 1, 3 openings 21 are formed for each liquid supply passage 18, and 2 openings 21 are formed for each liquid collection passage 19, in the cover member 20.

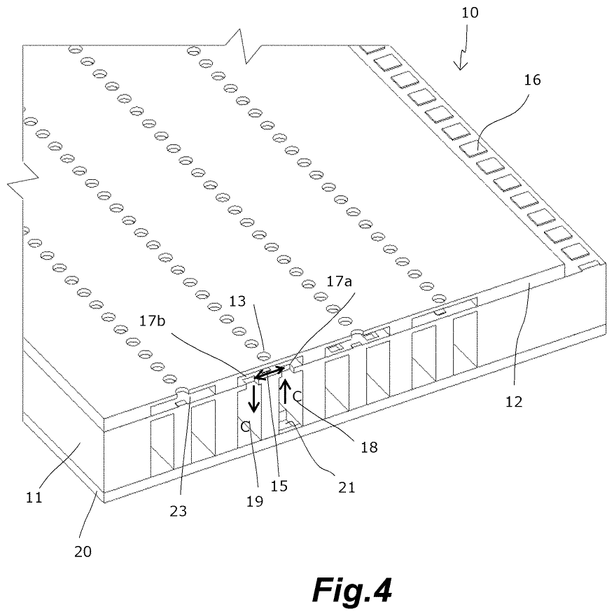

FIG. 4 is a perspective view indicating a cross-section of the element substrate 10 and the cover member 20 sectioned at the V-V line in FIG. 3A. As illustrated in FIG. 4, the cover member 20 has a function of a cover constituting a part of the walls of the liquid supply passage 18 and the liquid collection passage 19 formed on a substrate 11 of the element substrate 10. The cover member 20 is formed of a photosensitive resin material or a silicon plate, and the openings 21 are formed preferably by a photolithography process. The cover member 20 is for converting the pitch of the flow passage using the openings 21 like this, and preferably is thin and formed of a film type member considering the pressure loss.

A flow of the liquid inside the element substrate 10 will be described next. In the element substrate 10, the substrate 11 formed of Si and a nozzle forming member 12 formed of a photosensitive resin are layered, and the cover member 20 is bonded to the rear surface of the substrate 11. The nozzle forming member 12 is a first layer member of which surface the nozzles 13 are formed on, and the substrate 11 is a second layer member which is fixed to the rear surface of the nozzle forming member 12, which is the first layer member.

In the nozzle forming member 12, a pressure chamber 23, which is a first passage communicating with the nozzles 13, is disposed. The heaters 15 are formed on one surface side of the substrate 11, and grooves constituting the liquid supply passage 18 and the liquid collection passage 19 are formed extending along the nozzle array on the rear surface side thereof. In the substrate 11, the supply ports 17a, communicating with the pressure chamber 23, and the liquid supply passage 18 are disposed, and collection ports 17b, communicating with the pressure chamber 23, and the liquid collection passage 19 are disposed. Each of the liquid supply passage 18 and the liquid collection passage 19, formed by the substrate 11 and the cover member 20, is connected respectively to a common supply passage and a common collection passage in a passage member (not illustrated), and a differential pressure is generated between the liquid supply passage 18 and the liquid collection passage 19.

A nozzle 13 may not be performing the ejection operation while a plurality of nozzles 13 of the liquid ejection head 3 are ejecting liquid for recording. In such a nozzle 13, the liquid inside the liquid supply passage 18, dispose din the substrate 11, flow into the liquid collection passage 19 via the supply port 17a, the pressure chamber 23 and the collection port 17b (flow indicated by arrow C in FIG. 4) by the differential pressure mentioned above. In the nozzle 13 or the pressure chamber 23 where recording is paused, this flow allows the collection of high viscosity ink, foam, foreign substances and the like generated by evaporation from the nozzle 13 to the liquid collection passage 19. Further, an increase in the viscosity of ink in the nozzle 13 and the pressure chamber 23 can be suppressed by this flow.

The liquid collected in the liquid collection passage 19 passes through the opening 21 of the cover member 20, and then passes a communication port, an individual collection passage and a common collection passage sequentially in a passage member (not illustrated), and is finally collected to a supply passage of the recording device 1000.

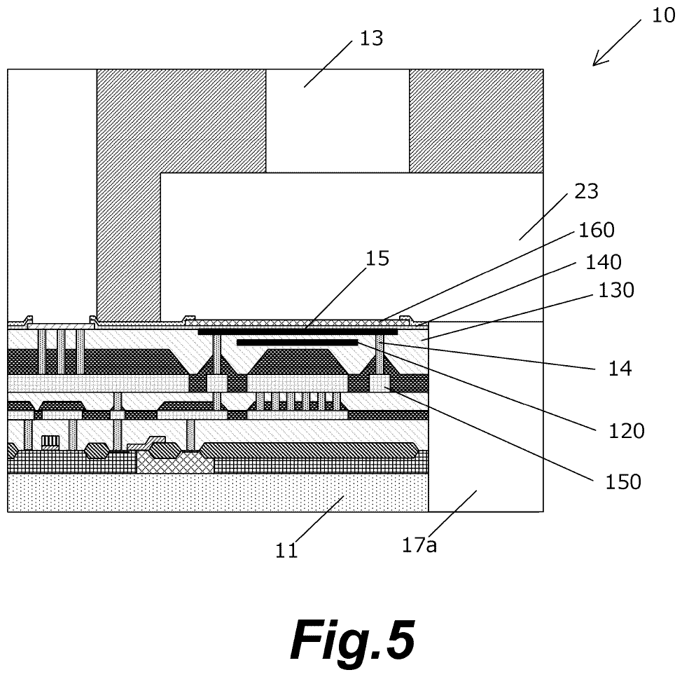

FIG. 5 is a cross-sectional view of the element substrate 10 at a portion around the nozzle 13. The element substrate 10 is formed on the substrate 11 (which is formed of silicon), and is constituted of a plurality of insulation layers and wiring layers which are laminated. The heater 15 and a temperature sensor 120 are connected to an external control device 900 via wiring patterns, conductive plugs and pads (terminals) disposed on a plurality of wiring layers. The heater 15 and the temperature sensor 120 are disposed for a number of places corresponding to the plurality of nozzles 13. A wiring pattern is formed of such metal material as Al, Al—Si and Al—Cu, for example, and a conductive plug is formed of tungsten, for example.

The heater 15 is disposed at a position facing the nozzle 13 in an insulation layer 130. The heater 15 is constituted of a rectangular thin film resistor formed of such material as TaSiN, which has high specific resistance and is thermally stable. A wiring 150 is connected to the heater 15 via a plug 14. The heater 15 is electrically connected to the external control device 900 through the wiring 150.

A protective layer 140 is disposed on the heater 15. The protective layer 140 is formed of an SiO film, an SiN film, or the like. A cavitation resistance layer 160 is formed on the protective layer 140. The cavitation resistance layer 160 protects the surface of the heater 15 from chemical and physical shock due to the heating of the heater 15.

A temperature sensor 120 is disposed under the heater 15 via the insulation layer 130, so as to partially overlap with the heater 15 in the plan view. The temperature sensor 120 is a sensor to detect the temperature change of the heater 15. The temperature sensor 120, just like the heater 15, is also electrically connected to the external control device 900 via the wiring and the plug (not illustrated in FIG. 5). The position of the temperature sensor 120 may be any position where the heat of the heater 15 reaches (e.g. above the heater 15, at side of the heater 15). The material of the temperature sensor 120 may be Ti/TiN or TaSiN, and the shape of the temperature sensor 120 may be a bar shape or meander shape.

The pressure chamber 23 has a configuration to circulate the ink in the liquid passage, where the liquid is supplied from the supply port 17a and the liquid is collected to the collection port 17b. On a heating resistor 126, the liquid is flowing in a direction from the supply port 17a (upstream side) to the collection port 17b (downstream side) during printing.

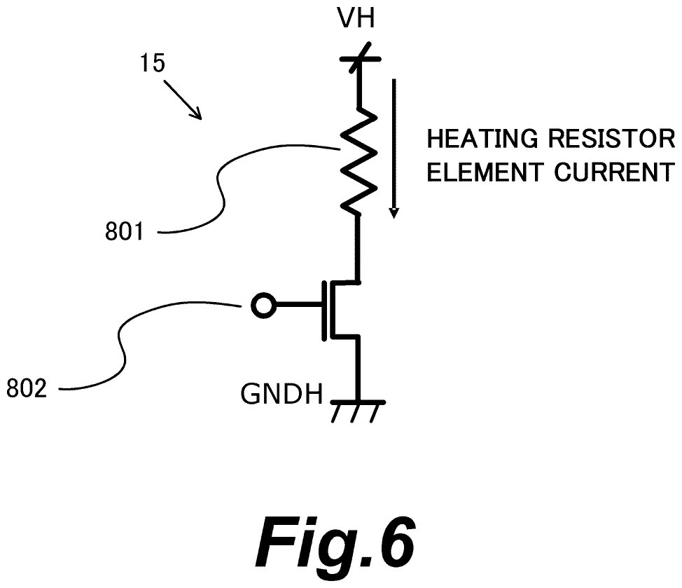

FIG. 6 is a diagram indicating a configuration of the heater 15. The heater 15 has a configuration where a resistor 801 and a transistor 802 are connected between a VH (power supply) wiring and a GNDH (ground) wiring. The heater 15 is disposed for each nozzle 13.

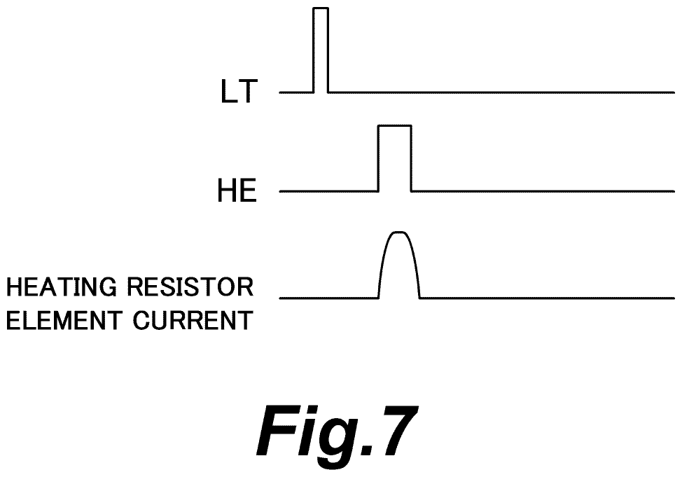

FIG. 7 is a conceptual timing chart indicating an operation of the heater 15. In the heater 15, the heater drive signal HE is input using the latch signal LT as a reference of the timing. When a pulse input as the heater drive signal HE is at H level, the transistor 802 turns ON, and current flows into the resistor 801, whereby the heater 15 heats up. This heats and foams the liquid inside the pressure chamber 23, and the liquid is ejected from the nozzle 13 thereby.

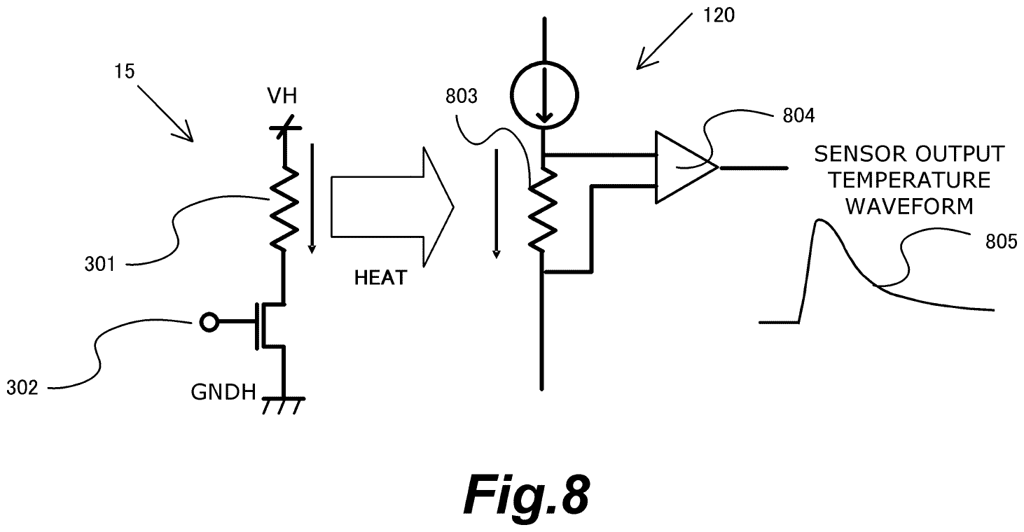

FIG. 8 is a schematic circuit diagram indicating a configuration of the temperature sensor 120. The temperature sensor 120 includes a resistor 803 and a voltage follower 804, and constant current is supplied to the resistor 803 and inter-terminal voltage of the resistor 803 is detected. This detected voltage depends on the temperature, hence if heat of the heater 15 is transferred to the temperature sensor 120 and the temperature changes, the change of the detected voltage is output as a waveform 805. The temperature sensor 120 is disposed for each heater 15.

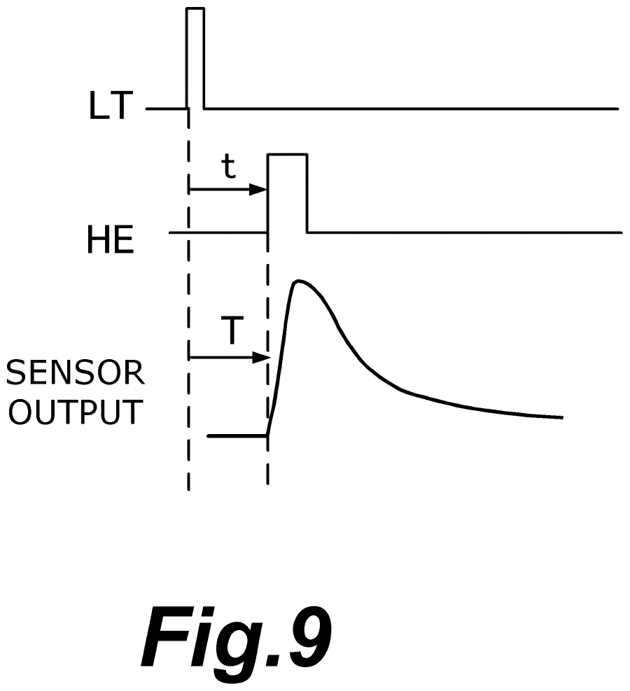

FIG. 9 is a conceptual timing chart indicating an operation of the temperature sensor 120. In the temperature sensor 120, a pulse of the heater drive signal HE is input to the heater 15 when time t elapsed from the fall of the latch signal LT, which is a reference of the timing. This supplies current to the heater 15 and the heater 15 heats up, then the heat of the heater 15 transfer to the temperature sensor 120, and a signal to indicate the temperature change is output from the temperature sensor 120 when time t elapsed from the rise of the latch signal LT.

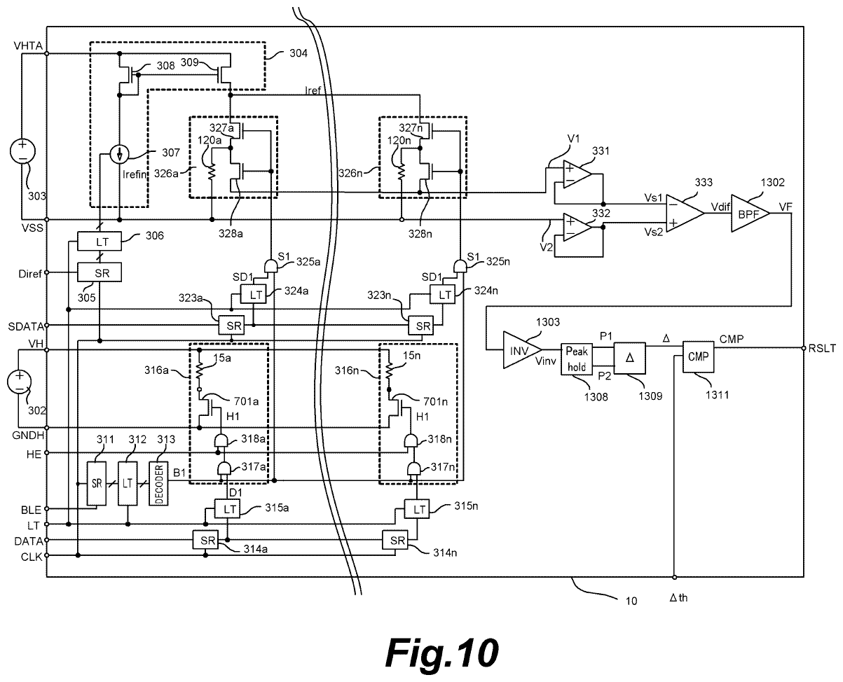

FIG. 10 is a block diagram of a drive circuit of the heater 15 and a processing circuit of the output signal of the temperature sensor 120 mounted on the element substrate 10. One heater 15 and one temperature sensor 120 are provided to each of the n number of nozzles 13. In the following description, the subscript (a to n), which indicates each nozzle 13, will be omitted unless the nozzle 13 is especially distinguished.

The element substrate 10 includes a constant voltage source 302 to drive the heater 15, a constant current source 304 to supply power to the temperature sensor 120, and an input/output unit (pad or terminal) to input/output signals and information to/from the outside. The constant voltage source 302 is connected between a VH pad and a GNDH pad. Further, as a power supply source to the constant current source 304, the constant voltage source 303 applies about 5V of VHTA to the high voltage side of the constant current source 304, for example, and applies VSS as GND to the low voltage side of the constant current source 304.

The constant current source 304 is constituted of a constant current source 309 using a same current type DAC 307 as a reference current source, and a constant current Iref is mirrored to the constant current source 309 at a same amplification factor by a mirroring circuit 308.

A set value Diref of the constant current Iref is transferred to a shift register 305 synchronizing with the clock signal CLK, then is latched by a latch circuit 306 synchronizing with the latch signal LT, and is output to a current output type digital/analog convertor (DAC) 307. In other words, the DAC 307 outputs an output current Irefin based on the set value Diref.

The output signal of the latch circuit 306 is held until the next latch timing, and during this time, the next set value Diref is transferred to the shift register 305. The output current Irefin of the DAC 307 is mirrored to the constant current source 309, is amplified 12 times, for example, and is then output as the constant current Iref.

A drive circuit 316 of the heater 15 is configured as a circuit to control applying of the voltage VH of the constant voltage source 302 to the heater 15. When the outputs of gate circuits 317 and 318 both become high and a switch element 701 turns ON, 24V of VH, for example, is applied to the high voltage side of the heater 15, and a source terminal of the switch element 701 is grounded to GNDH.

The block signal BLE is transferred to a shift register 311 synchronizing with the clock signal (CLK), is latched by a latch circuit 312, is decoded by a decoder 313, and is output to a wiring B1. The wiring B1 is connected to the gate circuit 317. Therefore, when the signal of the wiring B1 is enabled (High: active), the heater 15 can be driven.

The heater selection signal DATA is transferred to a shift register 314 synchronizing with the clock signal (CLK), is latched by the latch circuit 315, and is output to a wiring D1. The signal of the wiring D1 is held until the next latch timing, and during this time, the next heater selection signal is transferred to the shift register 314. The wiring D1 is connected to the gate circuit 317. Therefore, when the signal of the wiring D1 is enabled (High: active), the heater 15 can be driven.

The signal of the wiring B1 is input to the gate circuit 317 along with the signal of the wiring D1. The output signal of the gate circuit 317 is input to the gate circuit 318 along with the heat enable signal (HE). The gate circuit 318 outputs the pulse signal to a wiring H1. The wiring H1 is connected to the switch element 701, and the heater 15 is driven by the pulse signal.

A sensor drive circuit 326 is constituted of the temperature sensor 120, and switch elements 327 and 328. The switch element 327 controls the supply of current of the constant current source 309 to the temperature sensor 120. The switch element 328 controls output to a voltage follower 331 of the voltage generated in the temperature sensor 120. The switch elements 327 and 328 turn ON simultaneously, and at this time the temperature sensor 120 outputs the temperature signals, to inspect the ejection state of the liquid from the nozzle 13 corresponding to the heater 15, to the voltage followers 331 and 332 via wirings V1 and V2.

The sensor selection signal SDATA is transferred to a shift register 323 synchronizing with the clock signal (CLK), is latched by a latch circuit 324, and is output to a wiring SD1. The signal of the wiring SD1 is held until the next latch timing, and during this time, the next sensor selection signal is transferred to the shift register 323.

The wiring SD1 is connected to a gate circuit 325. Therefore, when the signal of the wiring SD1 is enabled (High: active), the temperature sensor 120 can be selected as a temperature sensor corresponding to the heater to be driven.

For a block signal to select the temperature sensor 120, the signal of the wiring B1 is used. In other words, the signal of the wiring B1 is input to the gate circuit 325 along with the signal of the wiring SD1.

The pulse signal is output to a wiring S1 by a gate circuit 325. The wiring S1 is connected to the switch elements 327 and 328, and the constant current Iref is supplied from the constant current source 309 to the temperature sensor 120 by the pulse signal.

A resistance Rs1 of the temperature sensor 120 at temperature Tl is given by the following expression (1), where TO is normal temperature, Rs0 is resistance in this state, and TCR is a temperature resistance coefficient of the temperature sensor 120.

$$Rs 1 = Rs 0 \cdot \{ 1 + TCR \cdot ( T 1 - T 0 ) \} \qquad ( 1 )$$

An output signal Vs1 generated at a constant current supply side terminal of the temperature sensor 120 is given by the following expression (2).

$$Vs 1 = Iref \cdot Rs 1 = Iref \cdot Rs 0 \cdot \{ 1 + TCR \cdot ( T 1 - T 0 ) \} \qquad ( 2 )$$

The output signal Vs1 given by expression (2) is output to the voltage follower 331 via the wiring V1.

An output signal Vs2 of a voltage follower 332 and the output signal Vs1 of the voltage follower 331 are differentially amplified by a differential amplifier 333, and are output to a bandpass filter 1302 as a signal Vdif, which indicates the voltage across the temperature sensor 120. The bandpass filter 1302 removes a high frequency noise from the signal Vdif, and cuts off low frequency components thereof by differential processing, and outputs the generated signal as a filter output signal VF. An inversion amplifier 1303 inverts and amplifies the filter output signal VF, and outputs the generated signal as a signal Vinv. In this signal Vinv, a positive peak, in accordance with the ejection state of the nozzle 13, appears.

### Determination Method of Comparative Example

A nozzle ejection determination method of a comparative example will now be described to compare with the nozzle ejection determination method of Embodiment 1.

In the case of ejecting liquid from the nozzle 13 using thermal energy generated by the heater 15, a differential value of the temperature change output from the temperature sensor 120 has a large peak value during normal ejection time, but the peak of the differential value of the temperature change becomes small if an ejection failure occurs. Therefore a method for determining the ejection state is comparing a peak of the differential value of the output of the temperature sensor 120 in a case of applying a drive pulse to the heater 15 with a threshold, and determining that ejection is normal if the peak value is the threshold or more, and that ejection fails if the peak value is smaller than the threshold. Here in order to determine the ejection state regardless the variation of the heater 15 and the temperature sensor 120 of each nozzle 13, it is preferable to set an appropriate threshold for each nozzle 13. For example, to set such a threshold, ejection is determined for the nozzle 13 to be determined while the threshold is sequentially increased in the state of consecutively applying the drive pulse to the heater 15, and the threshold at which the determination result changes from the normal ejection to the ejection failure is detected. If the nozzle 13 to be determined is the ejection failure from the beginning, the ejection determination is performed while the threshold is sequentially decreased in the state of consecutively applying the drive pulse to the heater 15, and the threshold at which the determination result changes from the ejection failure to the normal ejection is detected. By performing the ejection determination using the threshold detected in such processing (hereafter called “threshold setting processing”), the ejection detection can be performed regardless the variations of each nozzle.

This threshold setting processing is based on the assumption that the nozzle is in the normal ejection state, hence an appropriate threshold cannot be set if the nozzle is in the ejection failure state. Therefore, as a method for determining the ejection state of the nozzle, a method for determining the ejection state according to a comparative example will be described, so as to compare with Embodiment 1. First a second pulse having a pulse width shorter than a minimum drive pulse, which is to be applied to the heater to ejection ink from the nozzle, is consecutively applied to perform the threshold setting processing, whereby the threshold is set (second threshold). Then a first pulse, having a pulse width longer than the minimum drive pulse, is consecutively applied to perform the threshold setting processing, whereby the threshold is set (first threshold).

In the case of driving the heater 15 with the second pulse, the temperature sensor output corresponding to the ejection failure state is acquired. Therefore, the second threshold becomes a small value. On the other hand, in the case of driving the heater 15 with the first pulse, the temperature sensor output corresponding to the normal ejection state is acquired if the nozzle 13 is normal. Therefore, the first threshold becomes a large value. However, if the nozzle 13 is in the ejection failure state, the temperature sensor output corresponding to the ejection failure state is acquired, even if the heater 15 is driven with the first pulse. In this case, the second threshold becomes a value similar to the first threshold. In other words, the first threshold and the second threshold become completely different values if the nozzle is in the normal ejection state, but become similar values if the nozzle is in the ejection failure state. Hence whether the nozzle is in the normal ejection state or in the ejection failure state can be determined based on the difference between the first threshold and the second threshold. Specifically, the ejection is determined as normal if the difference is a predetermined threshold or more, and ejection is determined as a failure if the difference is smaller than the threshold.

### Flow Chart of Comparative Example

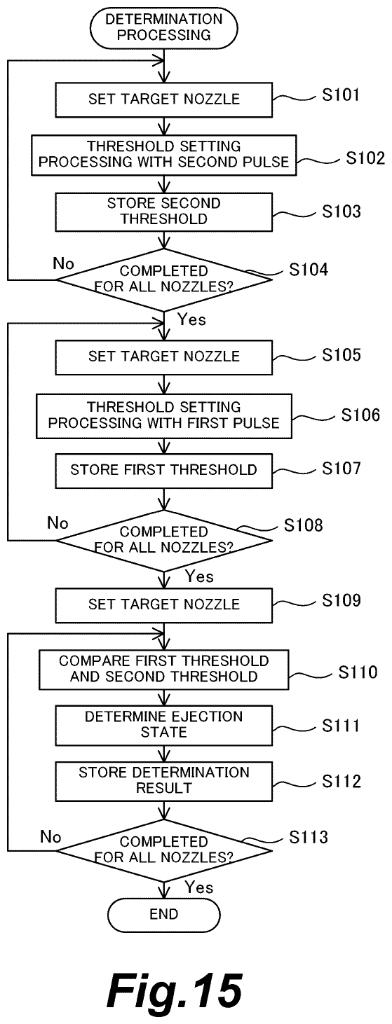

FIG. 15 is a flow chart indicating the ejection determination method of the comparative example. Initially first processing (step S101 to step S104) is performed. In step S101, the control unit sets a target nozzle of the threshold setting processing. In step S102, the control unit applies the second pulse to the heater, and performs the threshold setting processing for the target nozzle. In step S103, the control unit stores the threshold, at a timing when the determination result changed in the threshold setting processing in step S102, in the memory as the second threshold. In step S104, the control unit determines whether the second threshold is stored for all the nozzles, and repeats the processing in step S101 to step S103 until the second threshold is stored for all the nozzles.

After the first processing is over, the second processing (step S105 to step S108) is performed. In step S105, the control unit sets a target nozzle of the threshold setting processing. In step S106, the control unit applies the first pulse to the heater, and performs the threshold setting processing on the target nozzle. In step S107, the control unit stores the threshold, at a timing when the determination result changed in the threshold setting processing in step S106, in the memory as the first threshold. In step S108, the control unit determines whether the first threshold is stored for all the nozzles, and repeats the processing in step S105 to S107 until the first threshold is stored for all the nozzles.

After the second processing is over, ejection determination processing for each nozzle (step S109 to step S113) is performed. In step S109, the control unit sets a nozzle to be determined in the ejection determination processing. In step S110, the control unit compares the first threshold and the second threshold detected for the nozzle to be determined. In step S111, the control unit performs the ejection determination for the nozzle to be determined. In step S112, the control unit stores the ejection determination result for the nozzle to be determined in the memory. In step S113, the control unit determines whether the ejection determination result is stored for all the nozzles, and repeats the processing in step S110 to step S112 until the ejection determination result is stored for all the nozzles.

### Timing Chart of Comparative Example

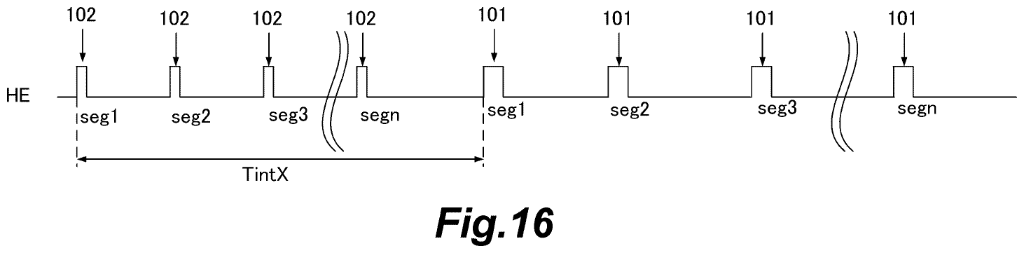

FIG. 16 is a timing chart schematically indicating the heater drive signal HE which is applied to the heater in the nozzle ejection determination processing of the comparative example. It is assumed that there are n number of nozzles to be determined in total, and the Xth nozzle is indicated by segX. In the ejection determination processing of the comparative example, the first processing is performed first where the second pulse 102 is applied in the sequence of nozzle seg1, seg2, seg3, . . . , segn. Then the second processing is performed, where the first pulse 101 is applied in the sequence of nozzle seg1, seg2, seg3, . . . , segn. Based on the information on the temperature change when the first pulse is input to the heater corresponding to the nozzle to be determined acquired in the first processing and the second processing, and the information on the temperature change when the second pulse is input thereto, the ejection determination is performed for the nozzle to be determined.

Time required for the first processing become longer in proportion to a number n of the nozzles. The second processing is performed after the first processing. In other words, in an interval between a timing when the first pulse is input to a heater corresponding to a certain nozzle in the first processing and the timing when the second pulse is input to this heater in the second processing, the first pulse is input to the heaters other than this heater. Therefore, the interval between the timing when the first pulse is input to a heater corresponding to a certain nozzle in the first processing and the timing when the second pulse is input to this heater in the second processing becomes a time longer than at least the time required for the first processing. This means that a long interval TinX exists between the timing when the second pulse is input to a heater corresponding to the nozzle to be determined and the timing when the first pulse is input to this heater. For example, as indicated in FIG. 16, there is a period to apply a pulse to other nozzles (seg2 to segn), from the time when the second pulse 102 is applied to the nozzle seg1 to the time when the first pulse 101 is applied to the nozzle seg1. Hence the interval TintX between the timing when the second pulse 102 is applied to the nozzle seg1 and the timing when the first pulse 101 is applied to the nozzle seg1 becomes longer in proportion to the number of nozzles. As the interval TintX becomes longer, various conditions that influence the ejection state (e.g. temperature, humidity, state of liquid) change between the time when the second pulse 102 was applied and the time when the first pulse 101 was applied, which makes accurate determination difficult. In the nozzle ejection processing of the comparative example, the sequence of the continuous application of the first pulse 101 and the consecutive application of the second pulse 102 may be reversed from the sequence of the example indicated in FIGS. 15 and 16.

### Determination Method of Embodiment 1

A nozzle ejection determination method of Embodiment 1 will be described next. As mentioned above, the peak of the differential value of the temperature change, output from the temperature sensor 120, is large in the case of the normal ejection, and the peak of the differential value of the temperature change is small in the case of the ejection failure. Based on this nature, the ejection state of the nozzle 13 is determined. Here the minimum drive pulse that should be applied to the heater 15 for the ink to be ejected from the nozzle 13 is assumed to be a “minimum pulse”. First the second pulse having a shorter pulse width than the pulse width of the minimum pulse is applied to the heater 15 corresponding to the nozzle 13 to be determined, and a peak of the differential value of the output of the temperature sensor 120 is detected (second peak value). Then a first pulse having a longer pulse width than the pulse width of the minimum pulse is applied to the heater 15 corresponding to the nozzle 13 to be determined, and a peak of the differential value of the output of the temperature sensor 120 is detected (first peak value).

In the case of driving the heater 15 with the second pulse, the temperature sensor output corresponding to the ejection failure state is acquired. Therefore, the second peak value becomes a small value. On the other hand, in the case of driving the heater 15 with the first pulse, the temperature sensor output corresponding to the normal ejection state is acquired if the nozzle 13 is normal. Therefore, the first peak value becomes a large value. However, if the nozzle 13 is in the ejection failure state, the temperature sensor output corresponding to the ejection failure state is acquired, even if the heater 15 is driven with the first pulse. In this case, the first peak value becomes a small value similar to the second peak value. In other words, the first peak value and the second peak value become completely different values if the nozzle 13 is in the normal ejection state, but become similar values if the nozzle 13 is in the ejection failure state. Hence whether the nozzle 13 is in the normal ejection state or in the ejection failure state can be determined based on the difference between the first peak value and the second peak value. Specifically, the nozzle 13 is determined as in a state of normally ejecting liquid if the difference between the first peak value and the second peak value is a predetermined threshold or more, and is determined as in the ejection failure state (state of not ejecting the liquid normally) if the difference between the first peak value and the second peak value is smaller than the threshold.

In Embodiment 1, in the ejection determination processing for the nozzle 13, the first peak value and the second peak value are detected by consecutively applying the first pulse and the second pulse to the heater 15 corresponding to the nozzle 13 to be determined, whereby the ejection determination is performed. By repeating this processing for each nozzle, the ejection determination is performed for all the nozzles 13 of the liquid ejection head 3. According to the ejection determination processing of Embodiment 1, the first pulse is input to the heater 15 corresponding to the nozzle 13 to be determined consecutively after the second pulse. In other words, in the interval between the input of the second pulse and the input of the first pulse to the heater 15 corresponding to the nozzle 13 to be determined, pulses are not input to the heaters 15 corresponding to the nozzles 13 which are not the ones to be determined. In the case of the above mentioned comparative example, pulses are input to the heaters 15 corresponding to all the nozzles 13 which are not the ones to be determined, in the interval between the input of the second pulse and the input of the first pulse to the heater 15 corresponding to the nozzle 13 to be determined. Therefore, the interval Tint between the timing when the second pulse is input to the heater 15 corresponding to the nozzle 13 to be determined and the timing when the first pulse is input thereto, can be shorter than the interval TintX of the above-mentioned comparative example. This means that various conditions that influence the ejection state (e.g. temperature, humidity, state of liquid) hardly changes between the time of applying the second pulse and the time of applying the first pulse, hence accurate ejection determination can be performed.

To implement this nozzle ejection determination processing of Embodiment 1, the element substrate 10 includes a peak hold circuit 1308 as indicated in FIG. 10. The peak hold circuit 1308 temporarily holds a first peak value P1 which appears in Vinv when the first pulse is applied to the heater 15, and a second peak value P2 which appears in Vinv when the second pulse is applied to the heater 15. The peak hold circuit 1308 outputs the first peak value P1 and the second peak value P2 to a circuit 1309. The circuit 1309 outputs a difference A of the first peak value P1 and the second peak value P2 to a determination circuit 1311. The determination circuit 1311 compares the difference Δ with a threshold Δth, and determines the ejection state of the nozzle 13 as the normal ejection if the difference Δ is the threshold Δth or more, or as ejection failure if the difference Δ is smaller than the threshold Δth.

The determination circuit 1311 outputs a determination result signal RSLT, which becomes high level in the next latch period in the normal ejection state. The determination result signal RSLT is extracted by a determination result extraction unit 5 indicated in FIG. 2, synchronizing with the fall of the latch signal LT, along with the block signal BLE and the sensor selection signal SDATA, which are delayed by the length of the latch period.

In the configuration described above, the determination unit from the differential amplifier 333 to the determination circuit 1311 is disposed inside the element substrate 10, but the determination unit may be disposed inside a control chip, which is included in the liquid ejection head 3, outside the element substrate 10. Further, the determination unit may be disposed in the control device 900 included in the recording device 1000, outside the liquid ejection head 3. The determination unit and the control device 900 are determination means for determining, for each of the plurality of nozzles 13 whether the nozzle is in the normal liquid ejection state based on the output of the temperature sensor 120.

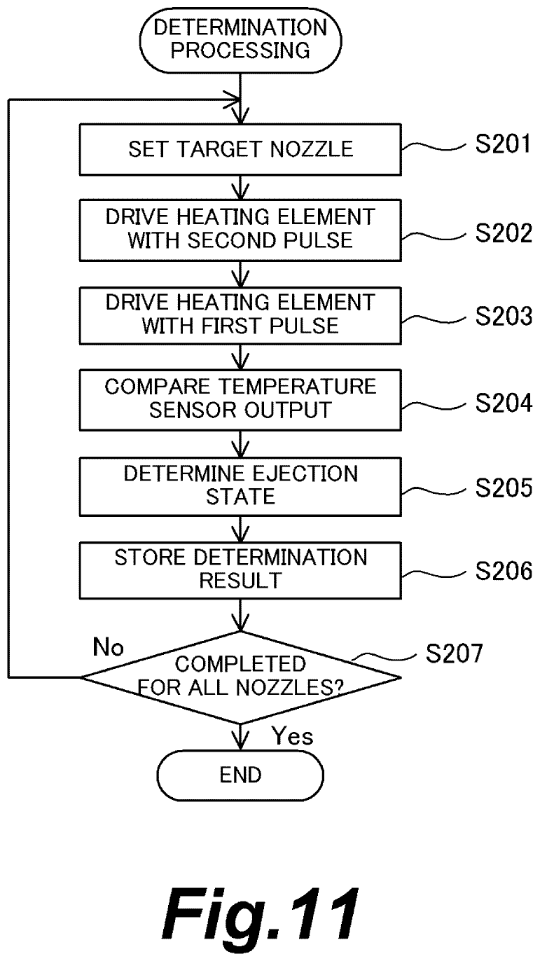

The ejection determination method of the nozzle 13 of Embodiment 1 will be described. FIG. 11 is a flow chart indicating an overview of the ejection determination method of Embodiment 1.

### Overview Flow Chart of Embodiment 1

FIG. 11 indicates an overview of the flow of the ejection determination processing of the nozzle 13 according to Embodiment 1. In step S201, the control device 900 sets a nozzle to be determined. In step S202, the control device 900 applies the second pulse to the heater 15, and acquires the output of the temperature sensor 120. In step S203, the control device 900 applies the first pulse to the heater 15, and acquires the output of the temperature sensor 120. In step S204, the control device 900 compares the temperature sensor output in step S202 and the temperature sensor output in step S203. In step S205, the control device 900 determines the ejection state of the nozzle 13 to be determined based on the comparison result in step S204. In step S206, the control device 900 stores the determination result in step S205 in the memory 203. In step S207, the control device 900 determines whether the ejection determination result is stored for all the nozzles 13, and repeats the processing in step S201 to step S206 until the ejection determination result is stored for all the nozzles 13.

### Flow Chart of Embodiment 1

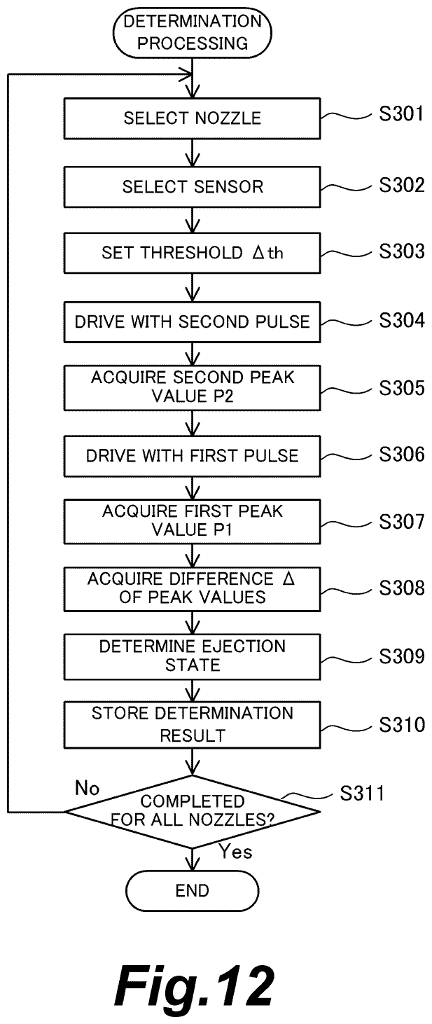

FIG. 12 is a flow chart indicating details of the nozzle ejection determination method of Embodiment 1. In step S301, the control device 900 selects a nozzle 13 to be determined. In step S302, the control device 900 selects a temperature sensor 120 corresponding to the nozzle 13 to be determined. In step S303, the control device 900 invokes a threshold Δth used for determination from the memory 203. In step S304, the control device 900 applies the second pulse to the heater 15 to drive the heater 15. In step S305, the control device 900 determines a peak value of the change rate (time derivative) of the output of the temperature sensor 120 when the heater 15 is driven with the second pulse (second peak value P2). The second peak value P2 is temporarily held by the peak hold circuit 1308 indicated in FIG. 10.

In step S306, the control device 900 applies the first pulse to the heater 15 to drive the heater 15. In step S307, the control device 900 determines a peak value of the change rate (time derivative) of the output of the temperature sensor 120 when the heater 15 is driven with the first pulse (first peak value P1). The first peak value P1 is temporarily held by the peak hold circuit 1308 indicated in FIG. 10. In step S308, the control device 900 determines a difference Δ=|P1−P2|, which is a difference between the first peak value P1 and the second peak value P2.

In step S309, the control device 900 determines the ejection state of the nozzle 13 to be determined based on the difference Δ determined in step S308. The control device 900 determines the normal ejection if the difference Δ is the threshold Δth or more, and determines the ejection failure if the difference Δ is smaller than the threshold Δth. The threshold Δth may be changed in accordance with the condition of using the liquid ejection head 3 or the like, and may be set accordingly in step S303. In step S310, the control device 900 stores the determination result in step S309 in the memory 203. In step S311, the control device 900 determines whether the ejection determination result is stored for all the nozzles 13, and repeats the processing in step S301 to step S310 until the ejection determination result is stored for all the nozzles 13.

The peak values temporarily held in the peak hold circuit 1308 are overwritten by peak values that are acquired when the ejection state is determined for the next nozzle 13 to be determined. Therefore, compared with the later mentioned comparative example, memory capacity can be reduced.

### Timing Chart of Embodiment 1

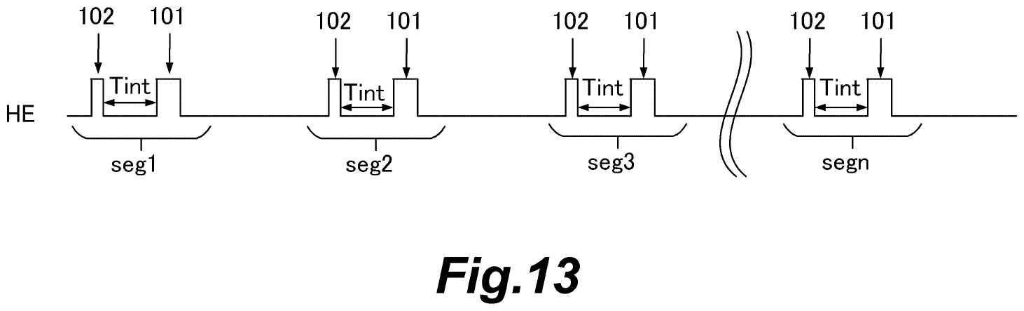

FIG. 13 is a timing char schematically indicating the heater drive signal HE, which is applied to the heater 15 in the nozzle ejection determination processing of Embodiment 1. It is assumed that there are n number of nozzles 13 to be determined in total, and the Xth nozzle 13 is indicated as segX. In the ejection determination processing, the second pulse 102 and the first pulse 101 are consecutively applied to the nozzle seg1 first, the peak values are acquired at each application, and the ejection determination is performed for the nozzle seg1. Then the second pulse 102 and the first pulse 101 are consecutively applied to the nozzle seg2, and the same processing is performed. This is repeated until processing for the nozzle segn.

Since the second pulse 102 and the first pulse 101 are consecutively applied to the nozzle seg1, there is no period to apply pulses to other nozzles (seg2 to segn) between applying the second pulse 102 to the nozzle seg1 and applying the first pulse 101 to the nozzle seg1. Hence the interval Tint between the timing of applying the second pulse 102 to the nozzle seg1 and the timing of applying the first pulse 101 to the nozzle seg1 is short, and does not depend on a number of nozzles. This means that various conditions that influence the ejection state (e.g. temperature, humidity, state of liquid) hardly change between the timing of applying the second pulse 102 and the timing of applying the first pulse 101, and the nozzle ejection determination can be accurately performed. In the nozzle ejection determination processing of Embodiment 1, the sequence of applying the first pulse 101 and the second pulse 102 to each nozzle 13 may be a reversal of the sequence indicated in the example of FIGS. 11 to 13.

### Operation Example of Embodiment 1

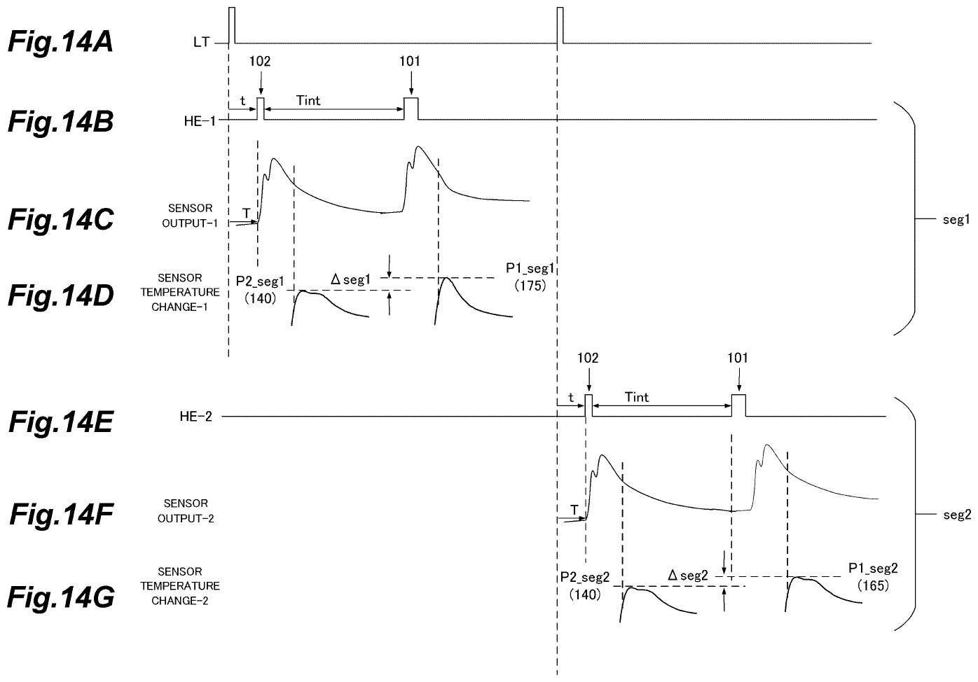

FIGS. 14A to 14G are timing charts indicating an operation of the heater 15 and the temperature sensor 120 in the nozzle ejection determination processing of Embodiment 1. FIG. 14A indicates the latch signal LT, FIG. 14B indicates the drive signal HE-1, which is input to the heater 15 of the nozzle seg1, FIG. 14C indicates the output signal of the temperature sensor 120 corresponding to the nozzle seg1, and FIG. 14D indicates the time derivative of the output signal of the temperature sensor 120 corresponding to the nozzle seg1. FIG. 14E indicates the drive signal HE-2, which is input to the heater 15 of the nozzle seg2, FIG. 14F indicates the output signal of the temperature sensor 120 corresponding to the nozzle seg2, and FIG. 14G indicates the time derivative of the output signal of the temperature sensor 120 corresponding to the nozzle seg2.

To the heater 15 corresponding to the nozzle seg1, the second pulse 102 (pulse width 0.15 μsec) is input when time t elapsed after the first LT signal is input. Thereafter the first pulse 101 (pulse width 0.35 μsec) is input when the interval Tint (10 μsec) elapsed. In the time derivative of the output signal of the temperature sensor 120 corresponding to the nozzle seg1, the second peak value P2_seg1 caused by the second pulse 102 and the first peak value P1_seg1 caused by the first pulse 101 appear.

To the heater 15 corresponding to the nozzle seg2, the second pulse 102 (pulse width 0.15 μsec) is input when time t elapsed after the second LT signal is input. Thereafter the first pulse 101 (pulse width 0.35 μsec) is input when the interval Tint (10 μsec) elapsed. In the time derivative of the output signal of the temperature sensor 120 corresponding to the nozzle seg2, the second peak value P2_seg2 caused by the second pulse 102 and the first peak value P1_seg2 caused by the first pulse 101 appear.

For example, it is assumed that the second peak value P2_seg1 of the nozzle seg1 is 140, the first peak value P1_seg1 thereof is 175, and the threshold Δth of the difference Δ of the peak values is 30. In this case, the difference of the two peak values Δseg1 is 175−140=35, that is, Δseg1≥Δth, hence it is determined that the nozzle seg1 is in the normal ejection state.

Further, it is assumed that the second peak value P2_seg2 of the nozzle seg2 is 140, and the first peak value P1_seg2 thereof is 165. In this case, the difference of the two peak values Δseg2 is 165−140=25, that is, Δseg2<Δth, hence it is determined that the nozzle seg2 is in the ejection failure state.

### Operation Example of Comparative Example

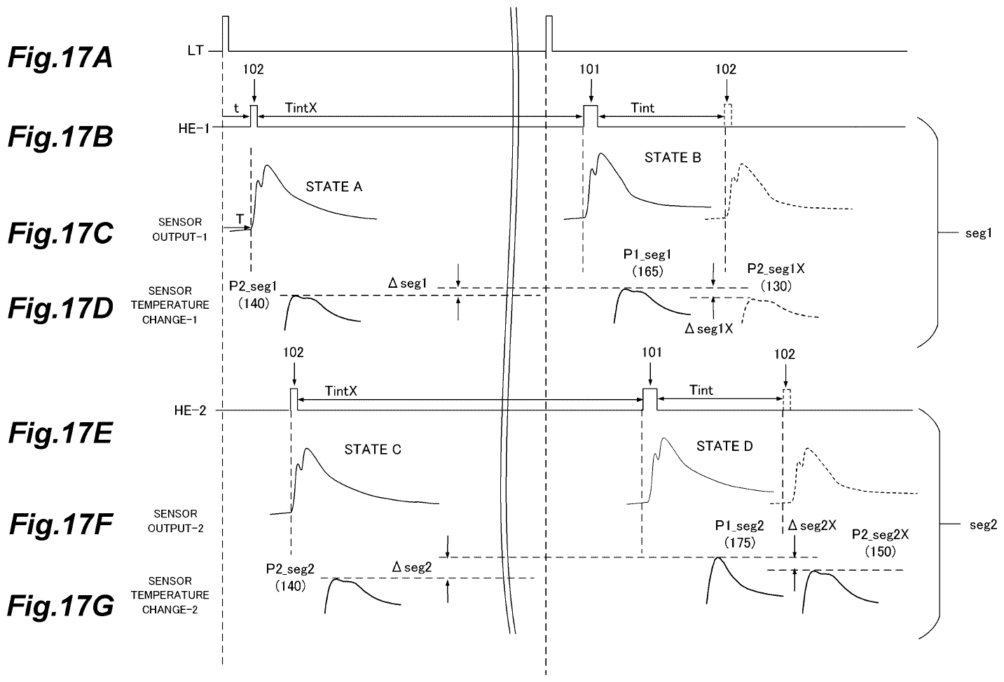

FIGS. 17A to 17G are timing charts indicating an operation of the heater and the temperature sensor in the nozzle ejection determination processing of the comparative example. FIG. 17A indicates the latch signal LT, FIG. 17B indicates the drive signal HE-1 which is input to the heater of the nozzle seg1, FIG. 17C indicates the output signal of the temperature sensor corresponding to the nozzle seg1, and FIG. 17D indicates the time derivative of the output signal of the temperature sensor corresponding to the nozzle seg1. FIG. 17E indicates the drive signal HE-2 which is input to the heater of the nozzle seg2, FIG. 17F indicates the output signal of the temperature sensor corresponding to the nozzle seg2, and FIG. 17G indicates the time derivative of the output signal of the temperature sensor corresponding to the nozzle seg2.

The second pulse 102 (pulse width 0.15 μsec) is input to the heater corresponding to the nozzle seg1, when time t1 elapsed after the first LT signal is input (state A), then the second pulse 102 is consecutively input to the heater corresponding to the nozzle seg2 (state C). The second pulse 102 is consecutively input to the heaters until the heater corresponding to the nozzle segn.

Then after the interval TintX elapsed, the first pulse 101 (pulse width 0.35 μsec) is input to the heater corresponding to the nozzle seg1 (state B), then the first pulse 101 is consecutively input to the heater corresponding to the nozzle seg2 (state D). The first pulse 101 is consecutively input to the heaters until the heater corresponding to the nozzle segn.

For example, it is assumed that an environmental change occurred between the state A and the state B, and the second peak value P2_seg1 of the nozzle seg1 acquired in the state A becomes 140, and the first peak value P1_seg1 thereof acquired in the state B becomes 165. In this case, the difference of the two peak values Δseg1 is 165−140=25, that is, Δseg1<Δth, hence it is determined that the nozzle seg1 is in the ejection failure state.

Further, it is assumed that an environmental change occurred between the state C and the state D, and the second peak value P2_seg2 of the nozzle seg2 acquired in the state C becomes 140, and the first peak value P1_seg2 thereof acquired in the state D becomes 175. In this case, the difference of the two peak values Δseg2 is 175−140=35, that is, Δseg2≥Δth, hence it is determined that the nozzle seg2 is in the normal ejection state.

As indicated by the broken lines in FIGS. 17A to 17G, it is assumed that the first pulse 101 is applied in the state B, then the second pulse 102 is consecutively applied after the short interval Tint similar to that of Embodiment 1, and the peak values are determined. In this case, the environmental change between the timing of applying the first pulse 101 and the timing of applying the second pulse 102 is small. Hence the second peak value P2_seg1X when the second pulse 102 is applied tends to be smaller than the state A, just like the case of the first peak value P1_seg1 when the first pulse 101 is applied. For example, it is assumed that the second peak value P2_seg1X is 130. In this case, the difference Δseg1X becomes 165−130=35, that is, the difference Δseg1X>Δth, hence it is correctly determined that the nozzle seg1 is in the normal ejection state.

Further, as indicated by the broken lines in FIGS. 17A to 17G, it is assumed that the first pulse 101 is applied in the state D, then the second pulse 102 is consecutively applied after the short interval Tint similar to that of Embodiment 1, and the peak values are determined. The second peak values P2_seg2X in the case of applying the second pulse 102 tends to be larger than the state C, just like the first peak value P1_seg2 in the case of applying the first pulse 101. For example, it is assumed that the second peak value P2_seg2X is 150. In this case, the difference Δseg2X becomes 175−150=25, that is, the difference Δseg2X <Δth, hence it is correctly determined that the nozzle seg2 is in the ejection failure state.

In this way, if the interval between the timing of detecting the first peak value and the timing of detecting the second peak value is long, determination may not be performed accurately due to the environment change. Whereas according to the nozzle ejection determination method of Embodiment 1, the interval of the timing of detecting the first peak value and the timing of detecting the second peak value is short, hence the determination can be accurately performed.

As described above, in the nozzle ejection determination method of Embodiment 1, the first pulse and the second pulse, of which heating of the heater 15 is difference from each other, are applied consecutively to the heater 15 to be determined, and the ejection determination is performed based on the change rate of the output of the temperature sensor 120 when each pulse is applied. Therefore, the interval between the timing of applying the first pulse and the timing of applying the second pulse is short, and environmental change between the liquid ejection by applying the first pulse and the liquid ejection by applying the second pulse is small. Therefore, the ejection state of the nozzle 13 can be accurately determined based on the temperature change caused by the first pulse and the temperature change caused by the second pulse.

In the above description, the second pulse is the drive pulse having a pulse width shorter than the minimum pulse width required to eject ink from the nozzle 13, and the first pulse is the drive pulse having a pulse width longer than the pulse width of the minimum pulse. Instead, the first pulse may be the drive pulse having a pulse width shorter than the minimum pulse width, and the second pulse width may be the drive pulse having a pulse width longer than the pulse width of the minimum pulse.

Further, in the above description, the first pulse and the second pulse are set based on the relationship to the minimum pulse width required to eject ink from the nozzle 13, but may be two different pulses of which heating of the heater 15 is different from each other. In other words, the first pulse and the second pulse may be two pulses of which thermal energy generated by the heater 15 is different from each other. In this case, the pulse width of each pulse may be determined such that the difference Δ between the first peak value and the second peak value when the nozzle 13 is in the ejection failure state, and the difference Δ between the first peak value and the second peak value when the nozzle 13 is in the normal ejection state are sufficiently different.

Further, in the example described above, the drive signal to drive the heater 15 is a signal to pulse-control the heating of the heater 15, but the drive signal is not limited to the signal to pulse-control the heating of the heater 15. In other words, the first drive signal and the second drive signal, of which heating of the heater 15 is different from the first drive signal, may be consecutively applied, and the ejection state of the nozzle may be determined based on the change rate of the output of the temperature sensor 120 when each drive signal is applied. The above description is an example of a case where the first drive signal includes the first pulse having a predetermined pule width, and the second drive signal includes the second pulse having a pulse width different from the pulse width of the first pulse. Further, in the example described above, the heating of the heater 15 is controlled by changing the pulse width of the drive signal, but the method of pulse control is not limited to the method of controlling the pulse width, as long as the heating of the heater 15 can be controlled.

### Embodiment 2

In Embodiment 2, the drive pulse, which is applied to the heater 15 when the nozzle ejection determination is executed, includes a main pulse and a subsequent sub-pulse of which pulse width is shorter than the main pulse. Thereby the sensitivity of the temperature sensor 120 is enhanced, hence the peak value increases and a more accurate nozzle ejection determination can be performed.

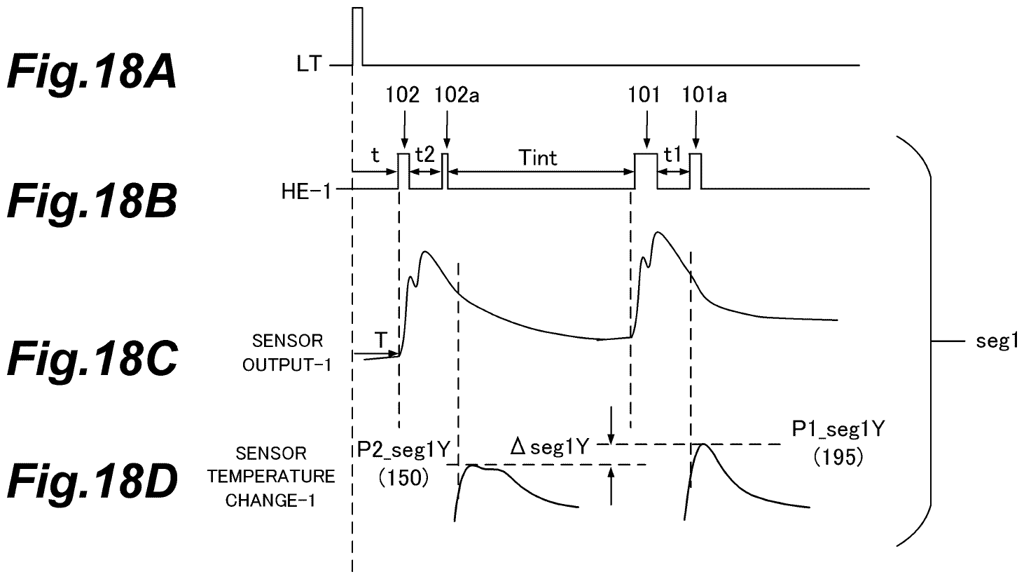

FIGS. 18A to 18D are timing charts indicating an operation of the heater 15 and the temperature sensor 120 in the nozzle ejection determination processing of Embodiment 2. FIG. 18A indicates the latch signal LT, FIG. 18B indicates the drive signal HE-1 which is input to the heater 15 of the nozzle seg1, FIG. 18C indicates the output signal of the temperature sensor 120 corresponding to the nozzle seg1, and FIG. 18D indicates the time derivative of the output signal of the temperature sensor 120 corresponding to the nozzle seg1.

To the heater 15 corresponding to the nozzle seg1, the second pulse 102 (pulse width 0.15 μsec), which is the main pulse, is input when time t elapsed after the first LT signal is input. Then a post-pulse 102a (pulse width 0.075 μsec), which is the sub-pulse, is input when the interval t2 (0.5 μsec) elapsed. Then the first pulse 101 (pulse width 0.35 μsec), which is the main pulse, is input after the interval Tint (10 μsec) elapsed. Thereafter a post-pulse 101a (pulse width 0.175 μsec), which is the sub-pulse, is input after the interval t1 (0.5 μsec) elapsed. In the time derivative of the output signal of the temperature sensor 120 corresponding to the nozzle seg1, the second peak value P2_seg1Y, caused by the second pulse 102 and the first peak value P1_seg1Y, caused by the first pulse 101, appear.

In Embodiment 1, the second peak value P2_seg1 of the nozzle seg1 is 140, but in Embodiment 2, it is assumed that the second peak value P2_seg1Y became 150 due to the effect of the post-pulse. Further, in Embodiment 1, the first peak value P1_seg1 thereof is 175, but in Embodiment 2, it is assumed that the first peak value P1_seg1Y became 195 due to the effect of the post-pulse. In this case, the difference of the two peak values Δseg1Y is 195−150=45, that is, Δseg1Y≥Δth, hence it is determined that the nozzle seg1 is in the normal ejection state. By applying the post-pulse like this, the sensitivity of the temperature sensor 120 is enhanced, and the difference Δ of the peak values increases, hence a more accurate nozzle ejection determination can be performed.

In the example in Embodiment 2, the post-pulse is applied for both the first pulse and the second pulse, but the post-pulse may be applied only for a pulse of which heating amount of the heater 15 is larger (first pulse in Embodiment 2).

### Embodiment 3

In Embodiment 3, the interval between the second pulse and the first pulse when the second pulse and the first pulse are consecutively applied to the heater 15, to execute the nozzle ejection determination, is set to shorter than in Embodiment 1. This interval is set to a time that is shorter than the time required for the temperature of the heater 15, due to the preceding pulse (second pulse in Embodiment 3), to return to the temperature before applying this pulse. Then the first pulse is applied while the heat generated by the second pulse remains near the temperature sensor 120, hence the sensitivity of the temperature sensor 120 can be enhanced, and a more accurate nozzle ejection determination can be performed.

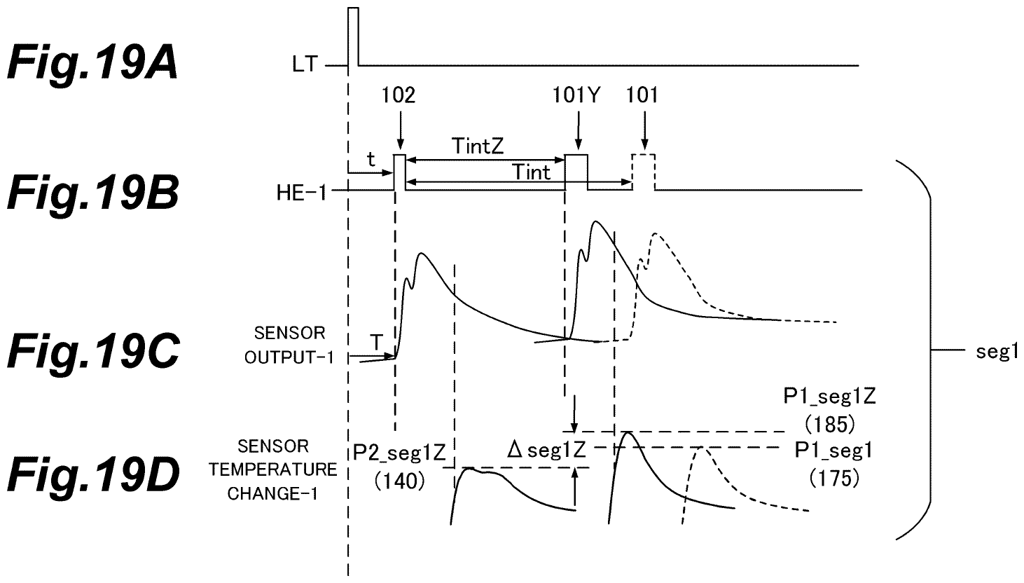

FIGS. 19A to 19D are timing charts indicating an operation of the heater 15 and the temperature sensor 120 in the nozzle ejection determination processing of Embodiment 3. FIG. 19A indicates the latch signal LT, FIG. 19B indicates the drive signal HE-1 which is input to the heater 15 of the nozzle seg1, FIG. 19C indicates the output signal of the temperature sensor 120 corresponding to the nozzle seg1, and FIG. 19D indicates the time derivative of the output signal of the temperature sensor 120 corresponding to the nozzle seg1.

To the heater 15 corresponding to the nozzle seg1, the second pulse 102 (pulse width 0.15 μsec) is input when time t elapsed after the first LT signal is input. Then the first pulse 101Y (pulse width 0.35 μsec) is input when the interval TintZ (6 μsec) elapsed. In the time derivative of the output signal of the temperature sensor 120 corresponding to the nozzle seg1, the second peak value P2_seg1Z, caused by the second pulse 102, and the first peak value P1_seg1Z caused by the first pulse 101, appear. As the broken lines indicate, the interval TintZ between the second pulse 102 and the first pulse 101Y is shorter than the interval Tint (10 μsec) between the second pulse 102 and the first pulse 101 in Embodiment 1.

In Embodiment 1, the second peak value P2_seg1 of the nozzle seg1 is 140, but in Embodiment 3, it is assumed that the second peak value P2_seg1Z became 140 since the conditions of the second pulse 102 are the same as those of Embodiment 1. Further, in Embodiment 1, the first peak value P1_seg1 is 175, but in Embodiment 3, it is assumed that the first peak value P1_seg1Z became 185 since the interval from the second pulse became short. In this case, the difference of the two peak values Δseg1Z is 185−140=45, that is, Δseg1Z≥Δth, hence it is determined that the nozzle seg1 is in the normal ejection state. By shortening the interval between the second pulse and the first pulse, the sensitivity of the temperature sensor 120 is enhanced, and the difference Δ of the peak values increases, hence a more accurate nozzle ejection determination can be performed.

### Embodiment 4

In Embodiment 4, when the second pulse and the first pulse are consecutively applied to the heater 15 to execute the nozzle ejection determination, the sequence of the second pulse and the first pulse are changed from Embodiment 1.

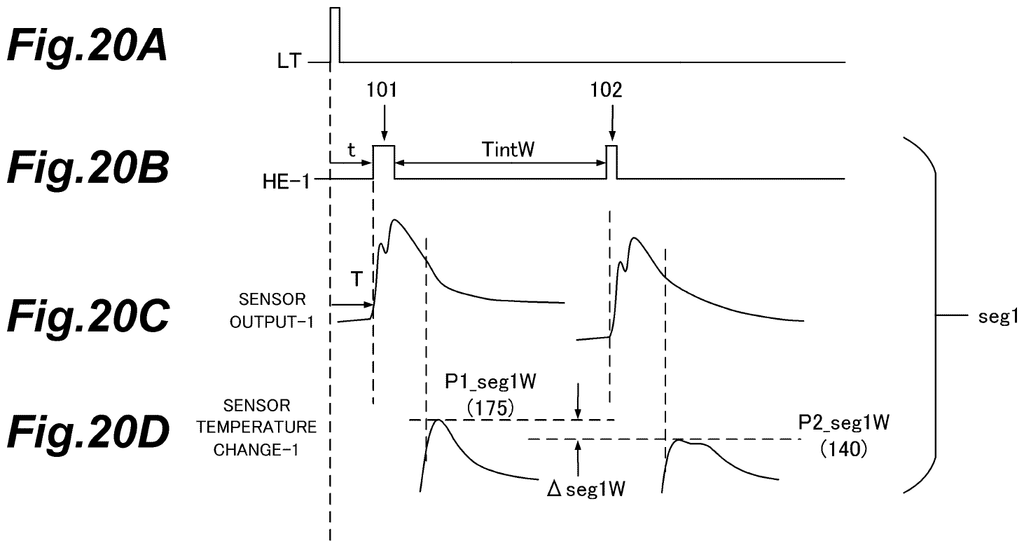

FIGS. 20A to 20D are timing charts indicating an operation of the heater 15 and the temperature sensor 120 in the nozzle ejection determination processing of Embodiment 4. FIG. 20A indicates the latch signal LT, FIG. 20B indicates the drive signal HE-1 which is input to the heater 15 of the nozzle seg1, FIG. 20C indicates the output signal of the temperature sensor 120 corresponding to the nozzle seg1, and FIG. 20D indicates the time derivative of the output signal of the temperature sensor 120 corresponding to the nozzle seg1.

To the heater 15 corresponding to the nozzle seg1, the first pulse 101 (pulse width 0.35 μsec) is input when time t elapsed after the first LT signal is input. Then the second pulse 102 (pulse width 0.15 μsec) is input when the interval TintW (12 μsec) elapsed. In the time derivative of the output signal of the temperature sensor 120 corresponding to the nozzle seg1, the first peak value P1_seg1W, caused by the first pulse 101, and the second peak value P2_seg1W, caused by the second pulse 102, appear.

In Embodiment 1, the first peak value P1_seg1 of the nozzle seg1 is 175, and in Embodiment 4, it is assumed that the first peak value P1_seg1W became 175 since conditions of the first pulse 101 are the same as those of Embodiment 1. Further, in Embodiment 1, the second peak value P2_seg1 of the nozzle seg1 is 140, but in Embodiment 4, it is assumed that the second peak value P2_seg1W became 140 since conditions of the second pulse 102 are the same as those of Embodiment 1. In this case, the difference of the two peak values Δseg1W is 175−140=35, that is, Δseg1W≥Δth, hence it is determined that the nozzle seg1 is in the normal ejection state. By applying the first pulse and the second pulse consecutively in this sequence, and performing the nozzle ejection determination as well, the nozzle ejection determination can be performed accurately, just like Embodiment 1.

According to the present disclosure, in the recording device using the liquid ejection head, which includes a heater to generate thermal energy to eject liquid for each nozzle, the ejection state of each nozzle can be accurately determined.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-213090, filed on Dec. 18, 2023, which is hereby incorporated by reference herein in its entirety.

What is claimed is:

1. A recording device comprising:
a liquid ejection head;
a processor; and
a memory,
wherein the recording device is configured to perform recording on a recording medium using the liquid ejection head,
wherein the liquid ejection head including:
a plurality of nozzles ejecting liquid;
a plurality of heaters heating the liquid disposed corresponding to the plurality of nozzles respectively;
a driving unit driving each of the plurality of heaters; and
a plurality of temperature sensors disposed corresponding to the plurality of heaters respectively;
wherein the memory stores instructions that, when executed by the processor, causes the recording device to:
consecutively apply a first drive signal and a second drive signal to a heater corresponding to a nozzle to be determined among the plurality of heaters by the driving unit, heating of the heater in a case where the second drive signal is applied being different from heating of the heater in a case where the first drive signal is applied, and
determine whether the nozzle to be determined is in a state of normally ejecting the liquid based on a change rate of an output of a temperature sensor corresponding to the nozzle to be determined among the plurality of temperature sensors acquired in a case where the first drive signal is applied and a change rate thereof acquired in a case where the second drive signal is applied, and
wherein, during an interval between the first drive signal and the second drive signal applied for the determination, a drive signal is not applied to heaters corresponding to the nozzles other than the nozzle to be determined among the plurality of heaters.

2. The recording device according to claim 1, wherein
the first drive signal and the second drive signal are signals to pulse-control the heating of the heater.

3. The recording device according to claim 2, wherein
the first drive signal includes a first pulse, and
the second drive signal includes a second pulse having a pulse width different from that of the first pulse.

4. The recording device according to claim 3, wherein
the pulse width of the first pulse is shorter than a minimum pulse width for ejecting liquid from the nozzle, and
the pulse width of the second pulse is longer than the minimum pulse width.

5. The recording device according to claim 3, wherein
the pulse width of the first pulse is longer than a minimum pulse width for ejecting liquid from the nozzle, and
the pulse width of the second pulse is shorter than the minimum pulse width.

6. The recording device according to claim 1, wherein
the determination for the nozzle to be determined is performed based on a first peak value indicating a peak of the change rate of the output of the temperature sensor in the case where the first drive signal is applied and a second peak value indicating a peak of the change rate of the output of the temperature sensor in the case where the second drive signal is applied.

7. The recording device according to claim 6, wherein
the determination for the nozzle to be determined is performed based on a difference between the first peak value and the second peak value.

8. The recording device according to claim 7, wherein
the nozzle to be determined is determined to be in the state of normally ejecting the liquid in a case where the difference is not less than a threshold, and
the nozzle to be determined is determined to be not in the state of normally ejecting the liquid in a case where the difference is smaller than the threshold.

9. The recording device according to claim 1, wherein
at least one drive signal of the first drive signal and the second drive signal of which heating of the heater is higher includes a main pulse and a sub-pulse following the main pulse and having a shorter pulse width than the main pulse.

10. The recording device according to claim 1, wherein
the first drive signal and the second drive signal include a main pulse and a sub-pulse following the main pulse and having a shorter pulse width than the main pulse.

11. The recording device according to claim 1, wherein
an interval between a timing of applying the first drive signal to the heater and a timing of applying the second drive signal to the heater is shorter than time for the temperature of the heater, which rose due to the first drive signal, to return to the temperature before applying the first drive signal.

12. A control method of a recording device configured to perform recording on a recording medium using a liquid ejection head including a plurality of nozzles ejecting liquid; a plurality of heaters heating the liquid disposed corresponding to the plurality of nozzles respectively; a driving unit driving each of the plurality of heaters; and
a plurality of temperature sensors disposed corresponding to the plurality of heaters respectively,
the control method comprising:
a step of consecutively applying a first drive signal and a second drive signal to a heater corresponding to a nozzle to be determined among the plurality of heaters by using the driving unit, heating of the heater in a case where the second drive signal is applied being different from heating of the heater in a case where the first drive signal is applied;
a step of acquiring a first output, which is an output of a temperature sensor corresponding to the nozzle to be determined among the plurality of temperature sensors in a case where the first drive signal is applied;
a step of acquiring a second output, which is an output of the temperature sensor corresponding to the nozzle to be determined among the plurality of temperature sensors in a case where the second drive signal is applied; and
a step of determining whether the nozzle to be determined is in a state of normally ejecting the liquid based on a change rate of the first output and a change rate of the second output,
wherein, during an interval between the first drive signal and the second drive signal applied for the determination, a drive signal is not applied to heaters corresponding to the nozzles other than the nozzle to be determined among the plurality of heaters.
